(19) United States
(12) Patent Application Publication
(10) Pub. No.: US 2023/0403670 A1
(43) Pub. Date: Dec. 14, 2023

(54) SIP-DEREGISTRATION BY EVOLVED PACKET CORE NETWORK

(71) Applicant: T-Mobile Innovations LLC, Overland Park, KS (US)

(72) Inventors: Praveen Singaram Muthukumar, Lawrenceville, NJ (US); Aziz Yunus Motiwala, Bothell, WA (US); Rahul Pal, Bothell, WA (US); Rushabhkumar Patel, Newcastle, WA (US)

(21) Appl. No.: 17/836,699

(22) Filed: Jun. 9, 2022

(51) Int. Cl. H04W 60/06; H04L 65/1016; H04W 76/30; H04M 15/00; H04L 65/1104; H04L 65/1045

(52) U.S. Cl. CPC H04W 60/06; H04L 65/1016; H04W 76/30; H04M 15/66; H04L 65/1104; H04L 65/1045

(57) ABSTRACT

Methods, media, and systems provide a more robust IP Multimedia Subsystem (IMS) deregistration process that deregisters a user equipment under circumstances that currently prevent a timely deregistration. For example, the aspects deregister a user equipment (UE) from an IMS core even when the UE disconnects from the Packet Data Network Gateway (PGW) or other EPC component without sending a SIP deregistration to the IMS core. The technology described herein automatically generates a deregistration message and communicates the message to the IMS core (e.g., a Session Termination Request Communication using Diameter Protocol between a PCRF & a P-CSCF) upon determining the session with the EPC is terminated. The UE is then deregistered from the IMS core.

### SUMMARY

A high-level overview of various aspects of the invention are provided to introduce a selection of concepts that are further described in the detailed-description section below. This summary is not intended to identify key features or essential features of the claimed subject matter, nor is it intended to be used as an aid in isolation to determine the scope of the claimed subject matter. The present disclosure is directed, in part, to systems and methods for enhanced selective attestation of wireless communications, substantially as shown in and/or described in connection with at least one of the figures, and as set forth more completely in the claims.

In aspects set forth herein, and at a high level, the systems and methods provide a more robust IP Multimedia Subsystem (IMS) deregistration process that deregisters a user equipment under circumstances that currently prevent a timely deregistration. For example, the aspects deregister a user equipment (UE) from an IMS even when the UE disconnects from the Packet Data Network Gateway (PGW) without sending a SIP deregistration to the IMS core. When a UE is operating correctly, the UE sends a deregistration message to both the IMS core and the Evolved Packet Core (EPC) upon terminating a session. However, a malfunctioning UE may disconnect from a network without sending a termination message to the IMS. This causes the UE to remain registered with the IMS core even though the UE is no longer in a communication session. The technology described herein automatically generates a deregistration message and communicates the message to the IMS core upon determining the session with the EPC is terminated. The UE is then deregistered from the IMS core.

Under current protocols, an (Internet Protocol) IP address is assigned to a UE upon initiating a communication session with the network. The IP address is associated with the UE within the IMS core through a registration process. The IP address is used to route packets to the UE.

IP addresses are reused within the network. Upon disconnecting from the network, the IP address assigned to the first UE may be put in an IP address queue and then eventually assigned to a second UE, which is also registered with the IMS using the same IP address. When the first device is not deregistered, then both devices may registered with the IMS under the same IP address. This double registration can cause routing issues within the network where messages intended for the first UE are routed the second UE. Intelligence exists, for example within ENodeB, to prevent the second UE from receiving the packets intended for the first UE. Nevertheless, the erroneous communication of these packets within the network wastes network resources and can cause errors within the network and with various network services.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWINGS

Implementations of the present disclosure are described in detail below with reference to the attached drawing figures, wherein:

FIG. 1 depicts an example communication environment with a EPC core and IMS core, in accordance with aspects herein;

FIG. 2 depicts an example deregistration message send to IMS core, in accordance with aspects herein;

FIG. 3 depicts an example sequence diagram illustrating communications occurring between components during deregistration of a UE, in accordance with aspects herein;

FIG. 4 illustrates an example flow diagram for deregistering a UE from an IMS core, in accordance with aspects herein;

FIG. 5 illustrates another example flow diagram for deregistering a UE from an IMS core, in accordance with aspects herein;

FIG. 6 illustrates yet another example flow diagram for deregistering a UE from an IMS core, in accordance with aspects herein; and

FIG. 7 depicts an exemplary computing environment suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
AOCN Administrative Operator Carrier Number
CA Carrier Aggregation
CD-ROM Compact Disk Read Only Memory
CDMA Code Division Multiple Access
CLLI Common Language Location Identifier
CSI Channel State Information
DVD Digital Versatile Discs
EEPROM Electrically Erasable Programmable Read Only Memory
eNB Evolved Node B
FD-MIMO Full-Dimension Multiple-Input Multiple-Output
FDD Frequency Division Duplex
gNB Next Generation Node B
GPRS General Packet Radio Service
GSM Global System for Mobile communications
HSS Home Subscriber Server
I-CSCF Interrogating Call Session Control Function
IBCF Interconnection Border Control Function
IoT Internet of Things
LTE Long Term Evolution
MAC Media Access Control
MID Management Instrumentation and Discovery
MIMO Multiple-Input Multiple-Output
MME Mobile Management Entity
MU-MIMO Multi-User Multiple-Input Multiple-Output
NR New Radio
OCN Operator Carrier Number
OFDM Orthogonal Frequency-Division Multiplexing
OTDOA Observed Time Difference of Arrival
P-CSCF Proxy Call Session Control Function
PC Personal Computer
PDA Personal Digital Assistant
PLMN Public Land Mobile Network
QoS Quality of Service
RAM Random Access Memory
RF Radio-Frequency
ROM Read Only Memory
RSRP Reference Transmission Receive Power
RSRQ Reference Transmission Receive Quality
RSSI Received Signal Strength Indicator
S-CSCF Serving Call Session Control Function
SIM Subscriber Identity Module
SINR Signal-to-Interference and Noise Ratio
SIP Session Initiation Protocol
SPID Service Provider ID
TAS Telephony Application Server
TDD Time Division Duplex
TDMA Time Division Multiple Access
UICC Universal Integrated Circuit Card
VLAN Virtual Local-Area-Network
VoIP Voice Over Internet Protocol
VoLTE Voice over LTE
VoNR Voice over NR

In addition, words such as “a” and “an,” unless otherwise indicated to the contrary, may also include the plural as well as the singular. Thus, for example, the constraint of “a feature” is satisfied where one or more features are present. Furthermore, the term “or” includes the conjunctive, the disjunctive, and both (a or b thus includes either a or b, as well as a and b).

Further, the term “some” may refer to “one or more.” Additionally, an element in the singular may refer to “one or more.” The term “combination” (e.g., a combination thereof, combinations thereof) may refer to, for example, “at least one of A, B, or C”; “at least one of A, B, and C”; “at least two of A, B, or C” (e.g., AA, AB, AC, BB, BA, BC, CC, CA, CB); “each of A, B, and C”; and may include multiples of A, multiples of B, or multiples of C (e.g., CCABB, ACBB, ABB, etc.). Other combinations may include more or less than three options associated with the A, B, and C examples.

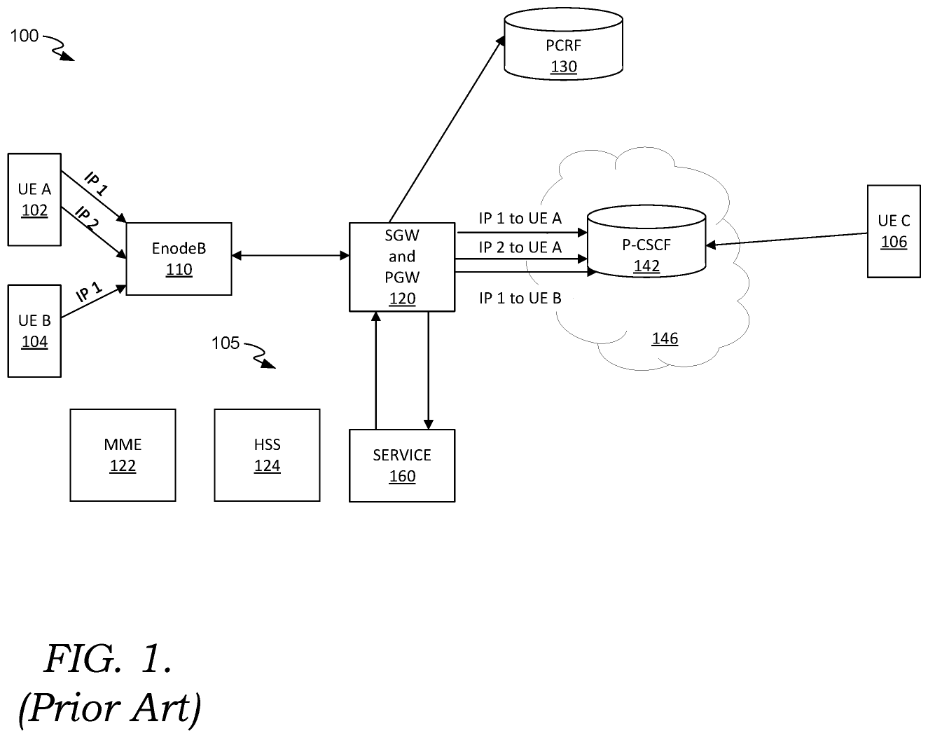

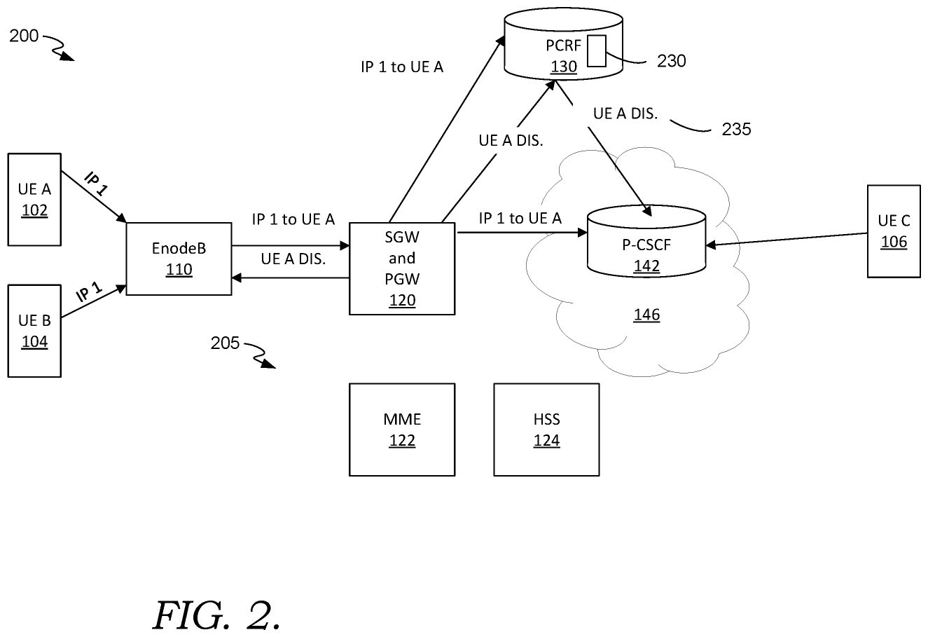

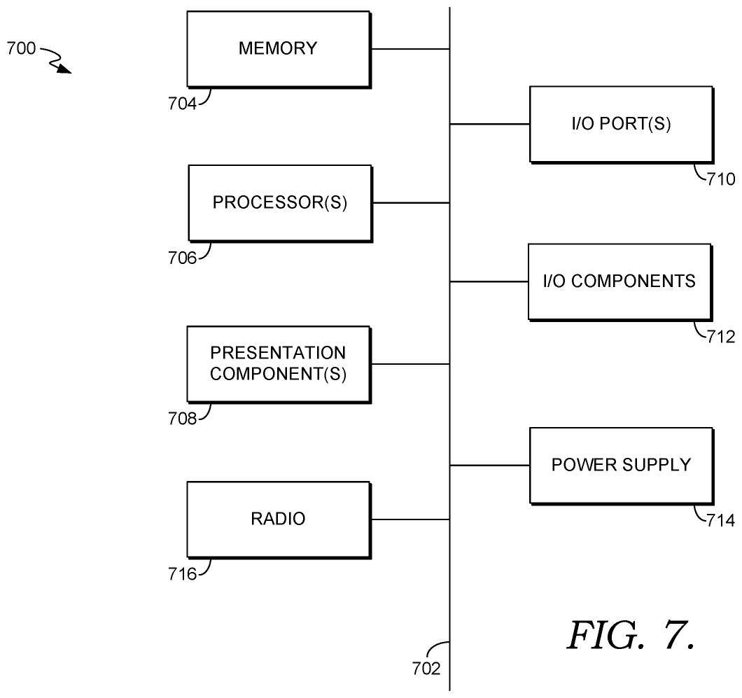

Additionally, a “computing device,” as used herein, is a device that has the capability of using a wireless communications network, and may also be referred to as a “user device,” “mobile device,” “user equipment,” “wireless communication device,” or “UE.” A computing device, in some aspects, may take on a variety of forms, such as a PC, a laptop computer, a desktop computer, a tablet, a mobile phone, a PDA, a server, or any other device that is capable of communicating with other devices (e.g., by transmitting or receiving a signal) using a wireless communication. A computing device may be, in an embodiment, similar to user equipment described herein with respect to FIGS. 1 and 2. A user device may also be, in another embodiment, similar to user device 700, described herein with respect to FIG. 7.

A computing device may additionally include internet-of-things devices, such as one or more of the following: a sensor, controller (e.g., a lighting controller, a thermostat), appliances (e.g., a smart refrigerator, a smart air conditioner, a smart alarm system), other internet-of-things devices, or combinations thereof. Internet-of-things devices may be stationary, mobile, or both. In some aspects, the user device is associated with a vehicle (e.g., a video system in a car capable of receiving media content stored by a media device in a house when coupled to the media device via a local area network. In some aspects, the user device comprises a medical device, a location monitor, a clock, other wireless communication devices, or a combination thereof.

In aspects, a computing device (i.e., user equipment) discussed herein may be configured to communicate using one or more of 4G (e.g., LTE), 5G, 6G, another generation communication system, or a combination thereof. In some aspects, the computing device has a radio that connects with a 4G cell site but is not capable of connecting with a higher generation communication system. In some aspects, the computing device has components to establish a 5G connection with a 5G gNB, and to be served according to 5G over that connection. In some aspects, the computing device may be an E-UTRAN New Radio-Dual Connectivity (ENDC) device. ENDC allows a user device to connect to an LTE eNB that acts as a master node and a 5G gNodeB that acts as a secondary node. As such, in these aspects, the ENDC device may access both LTE and 5G simultaneously, and in some cases, on the same spectrum band.

Wireless telecommunication services (e.g., the transfer of information without the use of an electrical conductor as the transferring medium) may be provided by one or more telecommunication network providers. Wireless telecommunication services may include, but are not limited to, the transfer of information via radio waves (e.g., Bluetooth®), satellite communication, infrared communication, microwave communication, Wi-Fi, millimeter wave communication, mobile communication, or a combination thereof. Embodiments of the present technology may be used with different wireless telecommunication technologies or standards, including, but not limited to, CDMA lxAdvanced, GPRS, Ev-DO, TDMA, GSM, WiMax technology, LTE, LTE Advanced, other technologies and standards, or a combination thereof.

A network providing the wireless telecommunication services may be a telecommunication network(s), or a portion thereof. A telecommunication network might include an array of devices or components (e.g., one or more cell sites). The network can include multiple networks, and the network can be a network of networks. In embodiments, the network is a core network, such as an evolved packet core, which may include at least one mobility management entity, at least one serving gateway, and at least one Packet Data Network gateway. The mobility management entity may manage non-access stratum (e.g., control plane) functions such as mobility, authentication, and bearer management for other devices associated with the evolved packet core.

In some aspects, a network can connect one or more computing devices to a corresponding immediate service provider for services such as 5G and LTE, for example. In aspects, the network provides wireless telecommunication services comprising one or more of a voice service, a message service (e.g., SMS messages, MMS messages, instant messaging messages, an EMS service messages), a data service, other types of wireless telecommunication services, or a combination thereof. In aspects, the wireless telecommunication services are provided to user devices or corresponding users that are registered or subscribed to a telecommunication service provider to utilize the one or more services. The network can comprise any communication network providing voice, message, or data service(s), such as, for example, a 1× circuit voice, a 3G network (e.g., CDMA, CDMA2000, WCDMA, GSM, UMTS), a 4G network (WiMAX, LTE, HSDPA), a 5G network, a 6G network, another generation network, or a combination thereof.

Components of the network, such as terminals, links, and nodes (as well as other components), can provide connectivity in various implementations. For example, components of the network may include core network nodes, relay devices, integrated access and backhaul nodes, macro eNBs, small cell eNBs, gNBs, relay cell sites, other network components, or a combination thereof. The network may interface with one or more cell sites through one or more wired or wireless backhauls. As such, the one or more cell sites may communicate to devices via the network or directly. Furthermore, user devices can utilize the network to communicate with other devices (e.g., a user device(s), a server(s), etc.) through the one or more cell sites.

As used herein, the term “cell site” (used for providing UEs with access to the telecommunication services) generally refers to one or more cellular base stations, nodes, RRUs control components, and the like (configured to provide a wireless interface between a wired network and a wirelessly connected user device). A cell site may comprise one or more nodes (e.g., eNB, gNB, or other nodes) that are configured to communicate with user devices. In some aspects, the cell site may include one or more band pass filters, radios, antenna arrays, power amplifiers, transmitters/receivers, digital signal processors, control electronics, GPS equipment, and the like. The one or more nodes corresponding to the cell site may comprise one or more of a macro base station, a small cell or femtocell base station, a relay base station, a combination thereof, and so forth. In aspects, the cell site may be configured as FD-MIMO, massive MIMO, MU-MIMO, cooperative MIMO, 3G, 4G, 5G, another generation communication system, or a combination thereof. In addition, the cell site may operate in an extremely high frequency region of the spectrum (e.g., from 30 GHz to 300 GHz), also known as the millimeter band.

Embodiments of the technology described herein may be embodied as, among other things, a method, system, or computer-program product. Accordingly, the embodiments may take the form of a hardware embodiment, or an embodiment combining software and hardware. An embodiment that takes the form of a computer-program product can include computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently. The computer-storage media is non-transitory and not a signal per se.

Communications media typically store computer-useable instructions—including data structures and program modules—in a modulated data signal (e.g., a modulated data signal referring to a propagated signal that has one or more of its characteristics set or changed to encode information in the signal). Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, prior methods and systems fail to deregister a UE from an IP Multimedia Subsystem (IMS) in some circumstances. These circumstances include when the UE fails to send a deregistration message upon disconnecting from the network. A malfunction in the UE may cause a deregistration message not to be sent.

The systems and methods provided herein can alleviate the problems discussed above. In aspects set forth herein, and at a high level, the systems and methods provide a more robust IP Multimedia Subsystem (IMS) deregistration process that deregisters a user equipment under circumstances that currently prevent a timely deregistration. For example, the aspects deregister a user equipment (UE) from an IMS even when the UE disconnects from the Packet Data Network Gateway (PGW) without sending a SIP deregistration to the IMS core. When a UE is operating correctly, the UE sends a deregistration message to both the IMS core and the Evolved Packet Core (EPC) upon terminating a session. However, a malfunctioning UE may disconnect from a network without sending a termination message to the IMS. This causes the UE to remain registered with the IMS core even though the UE is no longer in a communication session. The technology described herein automatically generates a deregistration message and communicates the message to the IMS core upon determining the session with the EPC is terminated. The UE is then deregistered from the IMS core.

Under current protocols, an (Internet Protocol) IP address is assigned to a UE upon initiating a communication session with the network. The IP address is associated with the UE within the IMS core through a registration process. The IP address is used to route packets to the UE.

IP addresses are reused within the network. Upon disconnecting from the network, the IP address assigned to the first UE may be put in an IP address queue and then eventually assigned to a second UE, which is also registered with the IMS using the same IP address. When the first device is not deregistered, then both devices may registered with the IMS under the same IP address. This double registration can cause routing issues within the network where messages intended for the first UE are routed the second UE. Intelligence exists, for example within ENodeB, to prevent the second UE from receiving the packets intended for the first UE. Nevertheless, the erroneous communication of these packets within the network wastes network resources and can cause errors within the network and with various network services.

Turning now to FIG. 1, a problem solved by the technology described herein in example telecommunications environment 100 is illustrated. The problem and components exist in the prior art. The environment 100 includes user device A 102, user device B, 104, and user device C 106. The environment 100 includes IMS core 146 and EPC core 105. The Evolved Packet Core (EPC) represents the Core of an LTE network. It is formed by multiple nodes, the main ones being MME (Mobility Management Entity) 122, S/PGW (Serving Gateway) and PGW (PDN Gateway) 120, HSS (Home Subscriber Server) 124, and PCRF (Policy and Charging Rules Function) 130. The nodes offer multiple functionality like mobility management, authentication, session management, setting up bearers and application of different Quality of Services.

The eNodeB 110 is the hardware that is connected to the user equipment network that communicates directly wirelessly with user equipment (102,104). In some aspects, eNodeB 110 may be part of a cell site that comprises a macro base station, a small cell or femto base station, a relay, and so forth. A cell site is deployed in a network to control and facilitate, via one or more antenna arrays, the broadcast, transmission, synchronization, and receipt of one or more wireless signals in order to communicate with, verify, authenticate, and provide wireless communications service coverage to one or more computing devices or other types of devices that request to join or are connected to the network.

The PGW 120 is the network node that connects the EPC to external IP networks. What the PGW does is that it routes packets to and from external IP networks. Beyond that, it also allocates an IP address to all UEs and enforces different policies regarding IP user traffic such as packet filtering.

The MME 122 performs signal functions in the core network 105. The MME 122 may be further configured to send and receive signaling information needed to set up and address calls to the base station(s) and contains security protocols for authentication and authorization.

The MME 122 may access a Home Subscriber Server (HSS) 124. The HSS 124 is a main subscriber data base that provides details of network subscribers to other entities, such as the MME 122, within a telecommunications network. The MME 122 may access the HSS 124 to verify an identity, and subscriber details, of the originating user equipment (102, 104) that are initiating a wireless communication with another client device within a destination network.

The PCRF node 130 may enable detection of communication service data flow and provide parameters for policy control and/or charging control. The PCEF (not shown) enforces the PCR rules by deciding whether data should go through the PGW 120 or not.

In various examples, an IP Multimedia Subsystem (IMS) core 146 may reside within the first telecommunications network environment 100. The IMS core 146 may include application function(s) 142, such as a Proxy Call Session Control Function (P-CSCF) 142 and other functions that are not shown for the sake of simplicity. These functions may include an Interrogating Call Session Control Function (I-CSCF), and a Serving Call Session Control Function (S-CSCF), a Telephone Application Server (TAS), an Interconnection Border Control Function (IBCF). The P-CSCF 142 behaves like a proxy by accepting requests and serving them internally or forwarding them towards to the I-CSCF and S-CSCF. The S-CSCF acts as a Session Initiation Protocol (SIP) registrar and in some cases as a SIP redirect server. The S-CSCF is responsible for processing the location registration of a client device, client authentication, call routing, and processing. The I-CSCF is tasked with selecting an S-CSCF for serving an initial SIP request, particularly when a client device initiating the request does not know which S-CSCF should receive the request. The IBCF is a network element deployed to protect the first telecommunications network, The IBCF may provide the first telecommunications network with measurements, access control, and data conversion facilities of communications received at the network edge.

The user equipment (102, 104, 106) may be configured to communicate by way of one or more transmissions with cell sites using 3G, 4G, 5G, another generation, or a combination thereof. Generally, a wireless communication session may be initiated by a request from an originating UE A 102 (as an example) to initiate a session with a destination device. The telecommunications network may then relay the request, and subsequently the communication, through the internet to a destination network and destination device or recipient. In some instances, the telecommunications network may provide attestation information for the identity of the originating UE. Attestation information improves the likelihood that the request to initiate a communication session between the originating UE A 102 and the destination client device will be completed at the destination device.

Initially, UE A102 is assigned a first IP address by the EPC core 105. This first IP address may be associated with the user equipment A 102 within the IMS core 146 via a SIP registration message communicated from the PGW 120 to IMS boundary component. The IMS core 146 maintains a registry of IP addresses and corresponding user equipment.

When the user equipment A 102 disconnects from the network, a disconnect message should be sent from the UE A 102 to the EPC core 105 and the IMS core 146. This may not occur if a malfunction within the user equipment is present. In this scenario, the EPC core 105 may recognize that the UE A 102 is no longer connected to eNodeB 110. Alternatively, the UE may send a detach message to the EPC core 105, but not the IMS core 146. The first IP address may then be disassociated with the UE A 102 within the EPC core 105 and freed for assignment to a second UE. In this example, the UE B 104 is assigned the first IP address after the UE A 102 has disconnected, but while the IMS core is still associating the first IP address with the UE A 102. This leaves the first IP address assigned to both UE A 102 and UE B 104 within the IMS core 146. If the UE A 102 rejoins the network, a second IP address may be assigned to UE A 102. This may cause the UE A 102 to be assigned to both the first IP address in the second IP address within the IMS core 146.

The duplicate assignment of a single IP address to two UEs within the IMS core 146 and/or the duplicate assignment of two IP addresses to a single UE within the IMS core 146 can cause routing problems. For example, packets from the UE C 106 intended for the UE B 102 may be misrouted via the IMS core 146. For example, a service 160 that should be receiving packets designated for the UE A 102, may instead receive packets intended for the UE B 104. Other processes may be in place within the system to recognize this error, but not to prevent the error from occurring in the first place. The technology described herein prevents this error from occurring.

Solving the duplicate IP address registration within the IMS core can reduce network bandwidth usage by correctly routing packets. The technology also improves the quality of service within the network by improving the probability that a packet is correctly routed by the network to an intended destination.

Turing now to FIG. 2, a communications environment 200 in which the deregistration of an IP address with the IMS core may occur is illustrated, according to aspects of the technology described herein. The components of FIG. 2 have been described previously with reference to FIG. 1. In addition to the previously described components, FIG. 2 includes a deregistration component 230. The deregistration component 230 is shown as a part of PCRF 130. However, the deregistration component 230 could be integrated with other EPC core components, such as MME 122 or PGW 120. Further, the functions performed by the deregistration component 230 could be distributed among multiple components within the EPC core.

Aspects of the technology described herein deregister a user equipment A 102 from an IMS core 146 even when the UE A 102 disconnects from the Packet Data Network Gateway (PGW) 120 (e.g., the EPC core) without sending a SIP deregistration to the IMS core 146. When a UE is operating correctly, the UE sends a deregistration message to both the IMS core 146 and the EPC Core 205 upon terminating a session. However, a malfunctioning UE may disconnect from a network without sending a termination message to the IMS core 146. This causes the UE and corresponding IP address to remain registered with the IMS core even though the UE is no longer in a communication session. The technology described herein automatically generates a deregistration message 235 and communicates the message to the IMS core 146 upon determining the session with the EPC is terminated. The EPC session may be terminated in response to a credit control request (CCR) termination message. Then the PCRF will send the will send a Session Termination Request to the IMS Core element (e.g., P-CSCF Element). The UE is then deregistered from the IMS core 146. The deregistration message may be communicated to an IMS core boundary component, such as the P-CSCF 142.

In one aspect, the PCRF 130 always communicates a termination message to the IMS core boundary component upon receiving a CCR termination message. This may cause the IMS boundary component to receive two disconnect requests (e.g., one from the UE and one from the PCRF) under normal operation of the UE. However, the multiple requests will ensure the IP address and UE are disassociated or deregistered within the IMS core. In other aspects, the PCRF 130 determines that a disconnect request was not sent through the EPC core to the IMS core. This determination may be made using a heuristic that identifies when a reregistration request is sent to the IMS core. For example, the heuristic may be: if a UE disconnects from the EPC core, then check whether a deregistration message is sent to the IMS core within a threshold time period. If a deregistration is sent to the IMS core, then no action is taken, if a deregistration is not sent to the IMS core then trigger generation of the deregistration message to the IMS core as part of the STR (Session Termination Request) initiated by PCRF. The determination (e.g., via heuristic) may be made by the PGW, which may be responsible for communicating a deregistration message that originates at the UE to the IMS core.

The result of deregistering the IP 1 from the IMS core is that messages directed from UE C 106 to UE B 104 will be received by UE B 104 and any services associated with UE B, rather than erroneously directed to UE A 102 when UE A 102 is no longer connected.

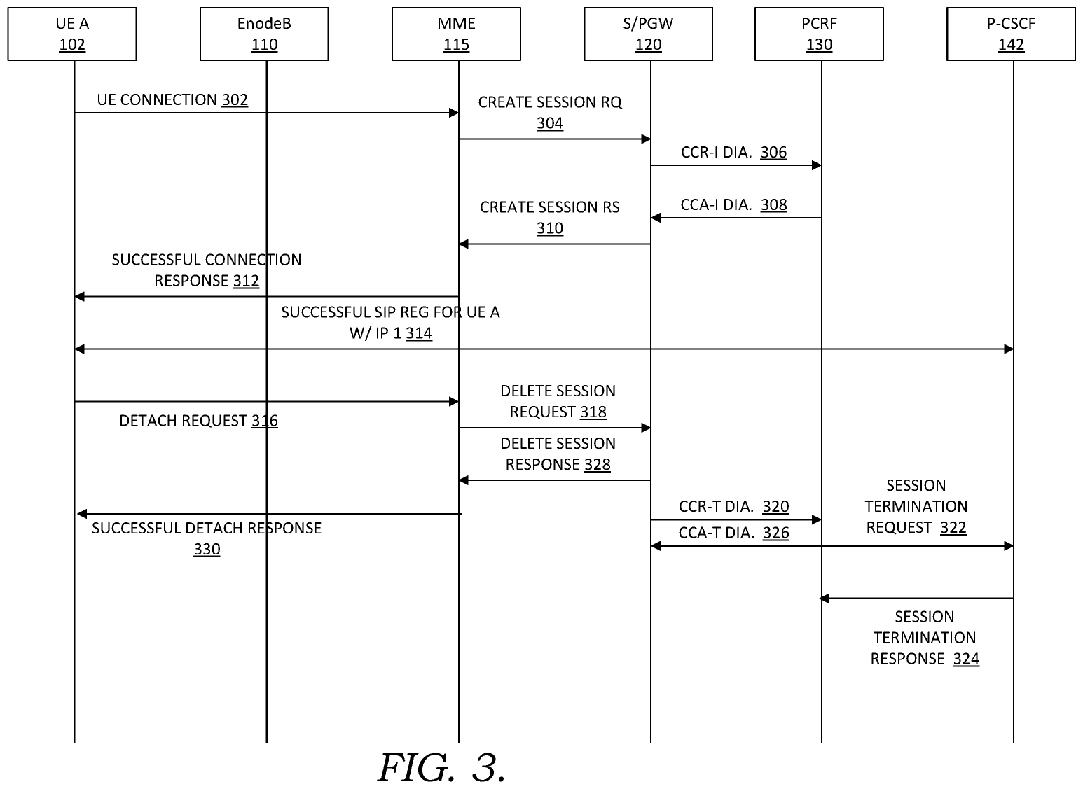

FIG. 3 illustrates communications occurring between components of FIG. 2 during registration and deregistration. Initially, a connection message 302 is sent from the UE A 102 to the eNodeB 110. The eNodeB initiates registration of the UE A 102 with the EPC core by forwarding the registration message 302 to MME 115. The MME communicates a session request message 304 to the gateways 120. The gateways 120 communicate a CCR initiation request 306 to the PCRF 130. The PCRF 130 acknowledges the initiation request 306 with a CCA response 308, which may include various rules that are applicable to the UE A 102. The gateways 120 send a session response message 310 to the MME 115. The MME 115 communicates a successful connection message 312 to the eNodeB 110 and UE A 102. This completes the registration process for UE A 102 within the EPC core. As part of the process, an IP address is assigned to the UE A 102. The assignment process may select the least recently used IP address from a pool of available IP addresses. Other methods of assigning IP addresses, such as random draw are possible.

In conjunction with the EPC core communication session initiation, the IP address assigned to UE A 102 is registered with the IMS core via a SIP registration message 314 sent to P-CSCF 142. Once the communication session is initiated, various communications (not shown) may be sent and received by the UE A 102.

In this example, a detach request 316 is sent from the UE A 102 to the MME 115. However, a SIP reregistration message is not sent from UE A to the IMS core, or IMS core components, such as P-CSCF 142. Upon receiving the detach request 316, the MME 115 sends a delete session request 318 to the gateways 120. Upon completion of detachment, the gateways 120 send a delete session response 328 to the MME 115. The MME 115 sends a successful detachment response 330 to the eNodeB 110 and UE A 102.

The gateways 120 send a CCR termination message 320 to the PCRF 130. Under the prior art, this message would not be sent and the IMS core would not be notified that the UE A 102 has disconnected from the network. The PCRF 142 sends a CCA termination acknowledgement message 326 to the gateways 320. Approximately in parallel with the CCA termination acknowledgement message 326, the PCRF then sends a SIP termination request 322 to the P-CSCF 142 of the IMS core. The P-CSCF 142 is just one example of an IMS core component that may receive the SIP request. The P-CSCF 142 initiates deregistration of the UE A 102 within the IMS core. This deregistration includes disassociating the IP address assigned to UE A 102 from UE A 102 within an IP address registry.

The P-CSCF 142 acknowledges the deregistration request through a SIP termination response 324. At the completion of this sequence of communications the IP address assigned to UE A 102 as part of the communication session would be disassociated with UE A 102 within both the EPC core and IMS core. Without the technology described herein, the IP address would still be associated with the UE A 102 within the IMS core.

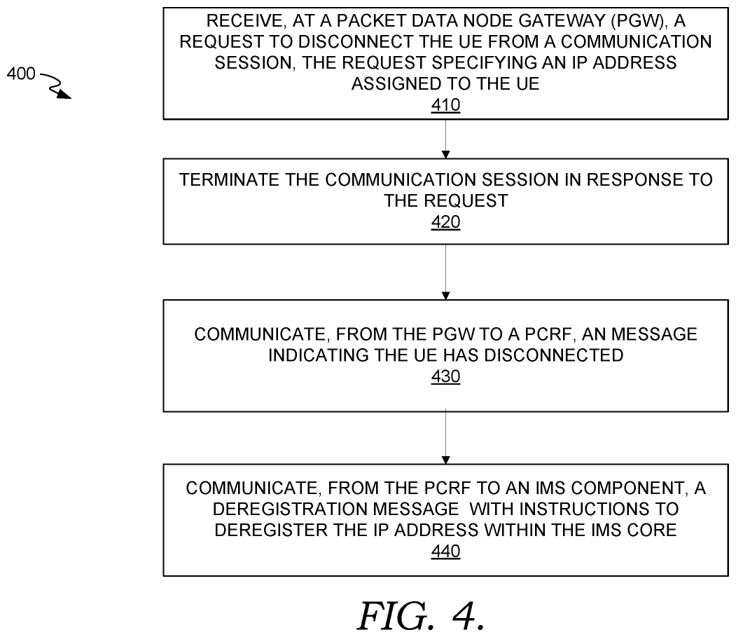

Now referring to FIGS. 4-6, each block of methods 400, 500, and 600, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The method may be provided by a standalone application, a service or hosted service (standalone or in combination with another hosted service), to name a few. In addition, methods 400, 500, and 600 are described, by way of example, with respect to the IMS deregistration component 230 of FIG. 2 and additional features of FIGS. 2-3. However, these methods may additionally or alternatively be executed by any one system, or any combination of systems, including, but not limited to, those described herein.

FIG. 4 is a flow diagram showing a method 400 of deregistering a UE with an IMS core. The method 400, at step 410, includes receiving, at a packet data node Gateway (PGW), a request to disconnect the UE from a communication session, the request specifying an IP address assigned to the UE. The request may originate from the UE.

The method 400, at step 420, includes terminating the communication session in response to the request.

The method 400, at step 430, includes communicating, from the PGW to a PCRF, a message indicating that the UE has disconnected.

The method 400, at step 440, includes communicating, from the PCRF, a deregistration message to an IMS component with instructions to deregister the IP address within the IMS core.

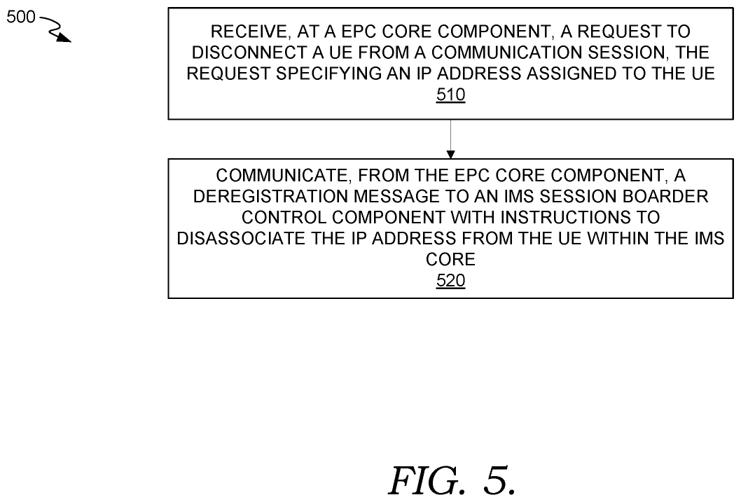

FIG. 5 is a flow diagram showing a method 500 of deregistering a UE with an IMS core. The method 500, at step 510, includes receiving, at a EPC core component, a request to disconnect a UE from a communication session, the request specifying an IP address assigned to the UE.

The method 500, at step 520, includes communicating, from the EPC core component, a deregistration message to an IMS session border control component with instructions to disassociate the IP address from the UE within the IMS core.

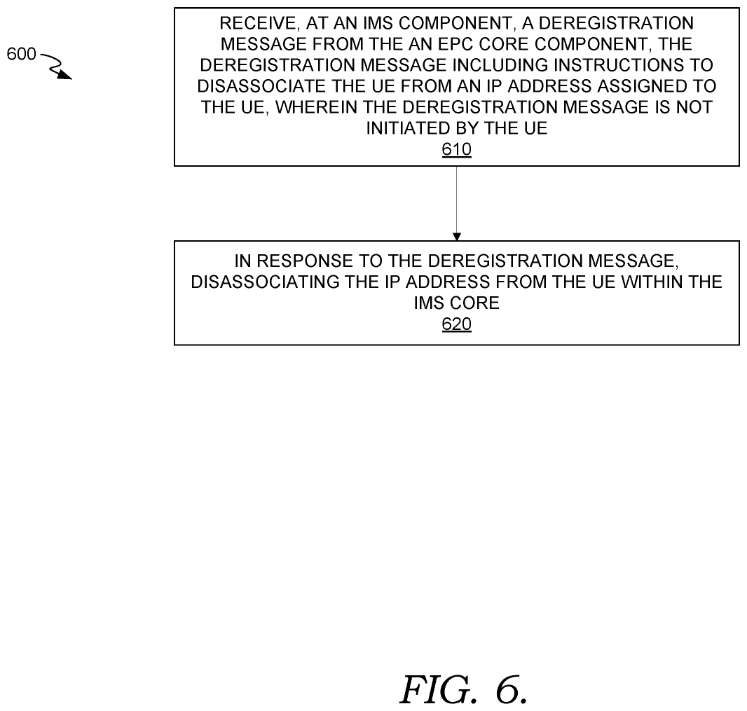

FIG. 6 is a flow diagram showing a method 600 of deregistering a UE with an IMS core. The method 600, at step 610, includes receiving, at an IMS component, a deregistration message from the EPC core component, the deregistration message including instructions to disassociate the UE from an IP address assigned to the UE, wherein the deregistration message is not initiated by the UE.

The method 600, at step 620, includes, in response to the deregistration message, disassociating the IP address from the UE within the IMS core.

Turning now to FIG. 7, a diagram is depicted of an exemplary computing environment suitable for use in implementations of the present disclosure. In particular, the exemplary computer environment is shown and designated generally as UE/user device 700. User device 700 is but one example of a suitable computing environment and is not intended to suggest any limitation as to the scope of use or functionality of the invention. Neither should user device 700 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 7, user device 700 includes bus 702 that directly or indirectly couples the following devices: memory 704, one or more processors 706, one or more presentation components 708, input/output (I/O) port(s) 710, I/O component(s) 712, power supply 714, and radio(s) 716. Bus 702 represents what may be one or more busses (such as an address bus, data bus, or combination thereof). Although the devices of FIG. 7 are shown with lines for the sake of clarity, in reality, delineating various components is not so clear, and metaphorically, the lines would more accurately be grey and fuzzy. For example, one may consider a presentation component such as a display device to be one of I/O component(s) 712. Also, processors, such as one or more processors 706, have memory. The present disclosure hereof recognizes that such is the nature of the art, and reiterates that FIG. 7 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 7 and refer to “user device.”

User device 700 typically includes a variety of computer-readable media. Computer-readable media can be any available media that can be accessed by user device 700. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Further, computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Turning to memory 704, memory 704 includes computer-storage media in the form of volatile or nonvolatile memory. Memory 704 may be removable, nonremovable, or a combination thereof. Examples of memory 704 include solid-state memory, hard drives, optical-disc drives, etc. For instance, memory 704 may include RAM, ROM, Dynamic RAM, a Synchronous Dynamic RAM, a flash memory, a cache memory, a buffer, a short-term memory unit, a long-term memory unit, or other suitable memory units. Removable memory may include, for example, a hard disk drive, a floppy disk drive, a Compact Disk drive, a CD-ROM drive, a DVD drive, or other suitable removable units.

Turning to the one or more processors 706, the one or more processors 706 read data from various entities such as bus 702, memory 704 or I/O component(s) 712. The one or more processors 706 include, for example, a Central Processing Unit, a Digital Signal Processor, one or more processor cores, a single-core processor, a dual-core processor, a multiple-core processor, a microprocessor, a host processor, a controller, a plurality of processors or controllers, a chip, a microchip, one or more circuits, circuitry, a logic unit, an IC, an ASIC, or any other suitable multi-purpose or specific processor or controller. Further, the one or more processors 706 execute instructions, for example, of an Operating System of the user device 700 or of one or more suitable applications.

Further, the one or more presentation components 708 present data indications to a person or other device. Examples of one or more presentation components 708 include a display device, speaker, printing component, vibrating component, etc. Additionally, I/O port(s) 710 allow user device 700 to be logically coupled to other devices including I/O component(s) 712, some of which may be built in user device 700. Illustrative I/O component(s) 712 include a microphone, joystick, game pad, satellite dish, scanner, printer, wireless device, etc. Furthermore, power supply 714 may include any suitable source of power, such as a rechargeable lithium polymer battery or an alternating current power converter.

Turning to radio 716, the radio 716 facilitates communication with a wireless telecommunication network. For example, radio 716 may facilitate communication via wireless communication signals, RF signals, frames, blocks, transmission streams, packets, messages, data items, or data. The terms “radio,” “controller,” “antenna,” and “antenna array” are used interchangeably to refer to one or more software and hardware components that facilitate sending and receiving wireless radio-frequency signals, for example, based on instructions from a cell site. Radio 716 may be used to initiate and generate information that is then sent out through the antenna array, for example, where the radio and antenna array may be connected by one or more physical paths. Generally, an antenna array comprises a plurality of individual antenna elements. The antennas discussed herein may be dipole antennas, having a length, for example, of ¼, ½, 1, or 1½ wavelength. The antennas may be monopole, loop, parabolic, traveling-wave, aperture, yagi-uda, conical spiral, helical, conical, radomes, horn, or apertures, or any combination thereof. The antennas may be capable of sending and receiving transmission via mmWaves, FD-MIMO, massive MIMO, 3G, 4G, 5G, or 802.11 protocols and techniques, etc.

Illustrative wireless telecommunications technologies that radio 716 may facilitate include CDMA, GPRS, TDMA, GSM, and the like. Radio 716 might additionally or alternatively facilitate other types of wireless communications including Wi-Fi, WiMAX, LTE, or other VoIP communications. As can be appreciated, in various embodiments, radio 716 can be configured to support multiple technologies or multiple radios can be utilized to support multiple technologies.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and sub combinations are of utility and may be employed without reference to other features and sub combinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. A system for deregistering a user equipment (UE) from an IMS core, the system comprising:
one or more processors; and
computer memory storing computer-usable instructions that, when executed by the one or more processors, perform operations comprising:
receiving, at a packet data node Gateway (PGW), a request to disconnect the UE from a communication session, the request specifying an IP address assigned to the UE;
terminating the communication session in response to the request;
communicating, from the PGW to a PCRF (Policy and Charging Rules Function), a message indicating the UE has disconnected; and
communicating, from the PCRF, a deregistration message to an IMS component with instructions to deregister the IP address within the IMS core.

2. The system according to claim 1, wherein the IMS component is a session border control component.

3. The system according to claim 2, wherein the session border control component is a Proxy-Call Session Control Function (P-CSCF).

4. The system according to claim 1, wherein the deregistration message is a SIP request.

5. The system according to claim 1, wherein the UE did not send a SIP deregistration message to the IMS core when disconnecting from a wireless telecommunication network that includes the IMS component.

6. The system according to claim 1, further comprising reassigning the IP address to a second UE.

7. The system according to claim 1, wherein the UE communicates a detach message to a Mobility Management Entity (MME) as part of a disconnection process.

8. The system according to claim 1, wherein a Mobility Management Entity (MME) determines the UE has disconnected and a deregistration message was not communicated to the MME by the UE.

9. A method for deregistering a user equipment (UE) from an IMS core, the method comprising:
receiving, at a EPC core component, a request to disconnect a UE from a communication session, the request specifying an IP address assigned to the UE; and
communicating, from the EPC core component, a deregistration message to an IMS session border control component with instructions to disassociate the IP address from the UE within the IMS core.

10. The method according to claim 9, wherein the request is initiated by the UE.

11. The method according to claim 9, wherein the EPC core component is selected from a group comprising a Mobility Management Entity (MME), a SGW (Serving Gateway) and PGW (PDN Gateway) and PCRF (Policy and Charging Rules Function).

12. The method according to claim 9, wherein the EPC core component determines the UE has disconnected and a deregistration message was not communicated to the EPC core component.

13. The method according to claim 9, wherein the UE did not send a deregistration message to the IMS core when disconnecting from a wireless telecommunication network that includes the IMS session border control component.

14. The method according to claim 9, wherein the IMS session border control component is a Proxy-Call Session Control Function (P-CSCF).

15. Non-transitory computer-readable media having computer-usable instructions embodied thereon that, when executed by a processor, perform operations for deregistering a user equipment (UE) from an IMS core, the operations comprising:
receiving, at an IMS component, a deregistration message from an EPC core component, the deregistration message including instructions to disassociate the UE from an IP address assigned to the UE, wherein the deregistration message is not initiated by the UE; and
in response to the deregistration message, disassociating the IP address from the UE within the IMS core.

16. The non-transitory computer-readable media of claim 15, determining, at the EPC core component, that the UE disconnected from a communication session facilitated by an EPC core.

17. The non-transitory computer-readable media of claim 15, wherein the IMS component is a session border control component.

18. The non-transitory computer-readable media of claim 17, wherein the session border control component is a Proxy-Call Session Control Function (P-CSCF).

19. The non-transitory computer-readable media of claim 15, wherein the EPC core component is a PCRF (Policy and Charging Rules Function).

20. The non-transitory computer-readable media of claim 19, wherein the UE did not send a SIP deregistration to the IMS core when disconnecting from a wireless telecommunication network that includes the IMS component.
